(19) United States
(12) Patent Application Publication
(10) Pub. No.: US 2002/0180340 A1
(43) Pub. Date: Dec. 5, 2002

(54) Materials and methods for mercury vapor pressure control in discharge devices

(76) Inventor: Steven C. Hansen, Urbana, IL (US)

Correspondence Address: D. Joseph English, DUANE MORRIS LLP, Suite 700, 1667 K Street, N.W., Washington, DC, 20006, US

(21) Appl. No.: 10/153,787

(22) Filed: May 24, 2002

Related U.S. Application Data
(60) Provisional application No. 60/293,167, filed on May 25, 2001.

(51) Int. Cl. H01J 17/26

(52) U.S. Cl. 313/490; 313/565

(57) ABSTRACT

A low pressure mercury vapor discharge device having a mercury vapor pressure regulating material contained in the discharge chamber thereof wherein the material is composed of silver, bismuth, and indium. The material may be introduced into the device as an amalgam or as an alloy separate from the mercury. The material in the form of an amalgam is particularly suitable for dosing precise amounts of mercury into fluorescent lamps and regulating the mercury vapor pressure during operation of the lamp.

### RELATED APPLICATIONS

This application claims the benefit of U.S. Provisional Patent Application No. 60/293,167.

### BACKGROUND OF THE INVENTION

The present invention relates to low-pressure mercury vapor discharge devices that contain a mercury vapor pressure regulating component, and more particularly to such lamps having an amalgam or one or more amalgam forming metals or alloys for regulating the mercury vapor pressure during operation of the lamp.

Low-pressure mercury vapor discharge devices such as fluorescent lamps contain mercury within a discharge chamber that is vaporized during operation of the lamp. The mercury vapor atoms efficiently convert electrical energy to ultraviolet radiation when the mercury vapor pressure is in the range of approximately 2×10⁻³ torr to approximately 2×10⁻² torr, and optimally at a pressure of about 6×10⁻³ torr. The optimal operating pressure of 6×10⁻³ torr corresponds to a vapor pressure in equilibrium with mercury at about 40° C. The temperature of the inner wall of the discharge chamber during operation of the device is referred to as the “cold spot temperature” of the device. Without a vapor pressure regulating component in the device, the cold spot temperature of the device determines the mercury vapor pressure during operation of the device.

When a fluorescent lamp containing only mercury operates with a cold spot temperature above about 40° C., the mercury vapor pressure exceeds the optimal pressure of 6×10⁻³ torr. As the mercury vapor pressure rises, the self-absorption of ultraviolet radiation by the mercury rises thus reducing the efficiency of the device.

The operating temperature of the device is determined primarily by the electrical power applied to the device, and by the amount of heat dissipated into the environment surrounding the device. In most applications of such devices, it is difficult to maintain the ambient temperature constant. Consequently, the cold spot temperature of the device will vary as will the efficiency and the light output of devices such as fluorescent lamps. For example, the operation of a lamp in an enclosed fixture with insufficient ventilation may result in a relatively high cold spot temperature resulting in reduced efficiency and light output from the lamp. Additionally, it is often desirable to raise the power applied to the lamp to thereby raise the radiance of the lamp. However, the rise in supply power may cause a rise in cold spot temperature and hence an undesirable rise in the mercury vapor pressure of the lamp.

It is well known that the mercury vapor pressure in such devices may be regulated by introducing one or more amalgamative metals, amalgamative alloys, or amalgams into the discharge chamber of the device that maintain the mercury vapor pressure substantially constant over a reasonably wide range of operating temperatures, typically between about 80° C. and about 120° C. Such amalgam controlled lamps rely on the establishment of thermodynamic equilibrium for proper lamp operation.

The amalgamative metal indium has proven to be a desirable mercury vapor pressure regulating component in discharge devices as it is well known that the introduction of an amalgam of indium and mercury into the discharge chamber of a fluorescent lamp results in a relatively wide temperature range in which the mercury vapor pressure may be maintained at an optimal pressure. However, the practical use of an amalgam of indium and mercury is limited due to the difficulty in obtaining sufficient mercury vapor pressure at low temperatures to effectively start the lamp. Further, indium is an expensive element and the cost of using an indium amalgam is therefore commercially undesirable.

U.S. Pat. No. 4,157,485 to Wesselink et al. discloses the use of a mercury vapor pressure regulating amalgam composed of bismuth, indium and mercury. While the amalgam disclosed by Wesselink et al. maintains a reasonably stable mercury vapor pressure at or near the optimal pressure of 6×10⁻³ torr over a wide temperature range, and also provides sufficient mercury vapor pressure at room temperature to effect lamp start-up, the material also contains a substantial amount of indium (nearly 30% by weight). Thus, while the mercury vapor pressure regulating characteristics of an amalgam composed of bismuth, indium and mercury are highly desirable; the cost of the indium in the material renders this material commercially undesirable.

U.S. Pat. No. 4,636,686 to Vrieze discloses a mercury vapor pressure regulating material composed of bismuth, lead and silver. The material disclosed by Vrieze suffers from the deficiency of providing a low mercury vapor pressure at room temperature and thus lamp start-up may be difficult. Further, the use of lead in the material is undesirable due to environmental concerns.

There remains a need for a mercury vapor pressure regulating material that provides desirable lamp starting and operating characteristics but reduces the amount of indium contained in the material, and eliminates lead from the material.

It is accordingly an object of the present invention to obviate many of the deficiencies of the prior art and to provide a novel low pressure mercury vapor discharge device with a controlled amount of mercury.

It is another object of the present invention to provide a novel low pressure mercury vapor discharge device that contains mercury in the form of an amalgam containing silver, bismuth and indium.

Still another object of the present invention is to provide a novel low pressure mercury vapor discharge device that contains an amalgamative alloy containing silver, bismuth and indium.

Yet another object of the present invention is to provide a novel low pressure mercury vapor discharge device having a mercury vapor pressure regulating material that maintains sufficient mercury vapor pressure at room temperature to effect device start-up.

Still yet another object of the present invention is to provide a novel low pressure mercury vapor discharge device having a mercury vapor pressure regulating material that maintains a desirable mercury vapor pressure over a wide range of operating temperatures.

A further object of the present invention is to provide a novel lamp fill material that is solid and easily handled at temperatures below about 40° C.

Yet a further object of the present invention is to provide a novel lamp fill material for fluorescent lamps containing a precise amount of mercury and sufficient amalgamative metals to maintain a desirable operating mercury vapor pressure over a wide range of temperatures.

Still a further object of the present invention to provide a novel method of introducing a precise amount of mercury into a fluorescent lamp.

Yet still a further object of the present invention to provide a novel method of maintaining a desirable mercury vapor pressure in a low pressure mercury vapor discharge device over a wide range of operating temperatures.

It is a further object of the present invention to provide a novel method of making a low pressure mercury vapor discharge device having a mercury vapor pressure regulating material comprising silver, bismuth, and indium.

It is still another object of the present invention to provide a novel fluorescent lamp, fill material, and method.

These and many other objects and advantages of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIG. 1 is a graphical illustration of the calculated mercury vapor pressure as a function of temperature for a prior art material and a material according to one aspect of the present invention.

FIG. 2 is a graphical illustration of the calculated mercury vapor pressure as a function of temperature for materials according the present invention having differing quantities of mercury.

### DESCRIPTION OF PREFERRED EMBODIMENTS

The present invention finds utility in low pressure mercury vapor discharge devices such as fluorescent lamps having a mercury vapor pressure regulating material contained in the discharge chamber thereof in the form of an amalgam or one or more amalgamative metals or alloys.

According to one aspect of the present invention, it has been discovered that an amalgam containing silver, bismuth, indium, and mercury introduced into the discharge chamber of a low pressure mercury vapor discharge device appears to be suitable for sufficiently regulating the mercury vapor pressure during operation of the device at an optimal pressure of about 6×10⁻³ torr over a wide range of operating temperatures. The amalgam further provides sufficient mercury vapor pressure at room temperature for effective device start-up.

In one embodiment, the ratio of the number of atoms of mercury in the amalgam to the sum of the number of atoms of silver, bismuth and indium is between about 0.005:995 and about 0.100:0.900. An amalgam having an atomic ratio of mercury to the amalgamative metals within this range has been found to sufficiently regulate the mercury vapor pressure at about 6×10⁻³ torr in a device with a cold spot temperature between about 80° C. and about 120° C. If the relative quantity of mercury exceeds about 0.150, the vapor pressure stabilizing function of the amalgam is substantially reduced and the luminous flux in the device will decrease at a higher rate as the cold spot temperature increases.

In this embodiment, the ratio of the number of atoms of indium in the amalgam to the number of atoms of bismuth is preferably between about 0.400:0.600 to about 0.200:0.800. The ratio of the number of atoms of silver in the amalgam to the sum of the number of atoms of bismuth and indium is preferably between about 0.010:0.990 to about 0.150:0.850.

The amalgam containing silver, bismuth, indium and mercury is mostly solid at room temperature and thus the amount of the amalgam to be introduced in the discharge chamber may be readily quantified and dispensed. For example, the amalgam may be in the form of one or more pellets having generally uniform mass and composition and a shape that facilitates handling and dosing into the devices. It has been found that generally spheroidal pellets having a diameter of about 200 to 3000 microns are preferred for dosing into fluorescent lamps.

The amalgam pellets may be formed by any suitable means. The generally spheroidal pellets having substantially uniform size and composition may be formed using the apparatus and methods disclosed in U.S. Pat. No. 4,216,178 issued Aug. 5, 1980 (and those patents issuing from related applications), all assigned to the assignee of the present invention and incorporated herein by reference. Pellets may be formed by these methods such as rapid solidification of molten amalgam having a size ranging from about 0.5 milligrams to about 90 milligrams with a deviation of about 10%. Other known techniques for making pellets such as die casting or extrusion may also be used.

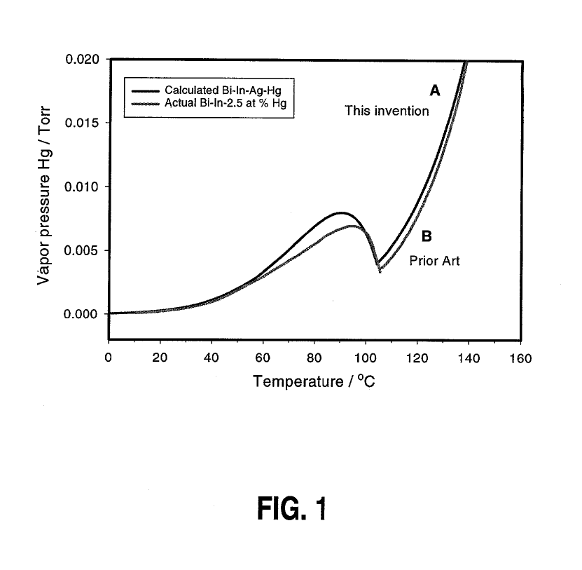

FIG. 1 is a graphical illustration of the calculated mercury vapor pressure as a function of temperature for a mercury vapor pressure regulating material according to the present invention (Curve A) and according to the prior art (Curve B). With reference to FIG. 1, the Curve B illustrates the calculated mercury vapor pressure as a function of temperature of an amalgam containing bismuth, indium and mercury in the atomic ratio of 55:42.5:2.5. As illustrated, this prior art material maintains the mercury vapor pressure at substantially about 6×10⁻³ torr over the temperature range of about 80° C. to about 120° C. The Curve A illustrates the calculated mercury vapor pressure as a function of temperature of a material according to one aspect of the present invention containing bismuth, indium, silver, and mercury in the atomic ratio of 66:31:1.5:1.5. As illustrated, the material according to the present invention maintains the mercury vapor pressure with a similar temperature dependence as the prior art material illustrated by the Curve B. Thus the material of the present invention sufficiently maintains the mercury vapor pressure as a function of temperature at substantially about 6×10⁻³ torr over a temperature range of about 80° C. to about 120° C., but contains substantially less indium than the prior art, and contains no lead.

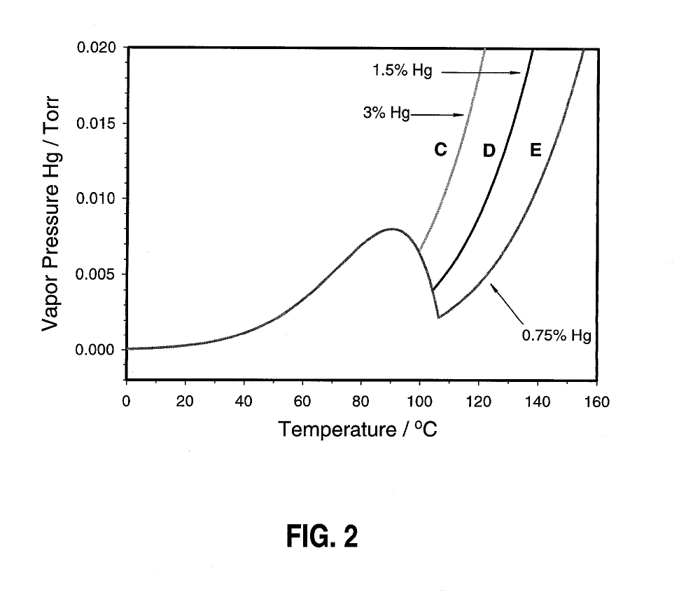

FIG. 2 is a graphical illustration of the calculated mercury vapor pressure as a function of temperature of an amalgam according to one aspect of the present invention containing bismuth, indium, silver and varying amounts of mercury. With reference to FIG. 2, the Curves C, D, and E illustrate the calculated mercury vapor pressure of an amalgam containing 3 atomic percent mercury, 1.5 atomic percent mercury, and 0.75 atomic percent mercury respectively. As illustrated in FIG. 2, the temperature range at which the mercury vapor pressure is reasonably stable may be changed by varying the atomic percentage of mercury in the amalgam, while such a variance in atomic percent mercury does not affect the mercury vapor pressure for device start-up at room temperature.

In an alternative embodiment of the present invention, the mercury vapor pressure regulating material may be introduced into the discharge chamber of the device as an alloy of bismuth, indium and silver, separate from the mercury.

While preferred embodiments of the present invention have been described, it is to be understood that the embodiments described are illustrative only and the scope of the invention is to be defined solely by the appended claims when accorded a full range of equivalence, many variations and modifications naturally occurring to those of skill in the art from a perusal hereof.

What is claimed is:

1. A low-pressure mercury vapor discharge device having a mercury vapor pressure regulating component contained within the discharge chamber thereof characterized in that said mercury vapor pressure regulating component comprises silver, bismuth and indium.

2. The device of claim 1 wherein said mercury vapor regulating component comprises an amalgam containing silver, bismuth and indium.

3. The device of claim 2 wherein said mercury vapor regulating component comprises one or more amalgam pellets.

4. The device of claim 1 wherein said mercury vapor regulating component comprises an alloy of silver, bismuth and indium.

5. The device of claim 1 wherein said device is a fluorescent lamp.

6. A fluorescent lamp having an amalgamative metal for controlling the mercury vapor pressure during operation of the lamp characterized in that the mercury in the lamp is in the form of an amalgam containing silver, bismuth and indium.

7. The fluorescent lamp of claim 6 wherein said amalgam forms one or more pellets.

8. The fluorescent lamp of claim 7 wherein said one or more amalgam pellets comprise between about 0.25 weight percent and about 30 weight percent silver.

9. The fluorescent lamp of claim 7 wherein said one or more amalgam pellets comprise less than about 30 weight percent indium.

10. The fluorescent lamp of claim 9 wherein said one or more amalgam pellets comprise about 20 weight percent indium.

11. The fluorescent lamp of claim 7 wherein said one or more amalgam pellets comprise between about 0.25 weight percent and about 8.0 weight percent mercury.

12. An amalgam controlled fluorescent lamp comprising one or more amalgam pellets containing silver, bismuth, and indium sealed within the light emitting chamber thereof.

13. The fluorescent lamp of claim 12 wherein the ratio of the number of atoms of mercury in said pellets to the sum of the number of atoms of silver, bismuth and indium is between about 0.005:0.995 and about 0.15:0.85.

14. The fluorescent lamp of claim 13 wherein the ratio of the number of atoms of mercury in said pellets to the sum of the number of atoms of silver, bismuth and indium is about 1.5:98.5.

15. The fluorescent lamp of claim 12 wherein the ratio of the number of atoms of indium to the number of atoms of bismuth is between about 0.4:0.6 and about 0.20:0.80.

16. The fluorescent lamp of claim 15 wherein the ratio of the number of atoms of indium to the number of atoms of bismuth is about 31:66.

17. The fluorescent lamp of claim 12 wherein the ratio of the number of atoms of silver to the sum of the number of atoms of bismuth and indium is between about 0.01:0.99 and about 0.15:0.85.

18. The fluorescent lamp of claim 17 wherein the ratio of the number of atoms of silver to the sum of the number of atoms of bismuth and indium is about 1.5:97.0.

19. The fluorescent lamp of claim 12 wherein said one or more pellets are formed by solidifying molten amalgam.

20. The fluorescent lamp of claim 12 wherein said one or more pellets are formed by die casting.

21. A low-pressure mercury vapor discharge lamp having an amalgam disposed within the light emitting chamber thereof, said amalgam comprising bismuth, indium, and silver.

22. The lamp of claim 21 wherein said amalgam is characterized in that the ratio of the number of atoms of mercury to the sum of the number of atoms of bismuth, indium and silver is between about 0.005:0.995 and about 0.15:0.85.

23. The lamp of claim 21 wherein said amalgam is characterized in that the ratio of the number of atoms of indium to the number of atoms of bismuth is between about 0.4:0.6 and about 0.20:0.80.

24. The lamp of claim 21 wherein said amalgam is characterized in that the ratio of the number of atoms of silver to the sum of the number of atoms of bismuth and indium is between about 0.01:0.99 and about 0.15:0.85.

25. A fluorescent lamp comprising:
a sealed glass envelope forming a light emitting chamber;
a pair of spaced electrodes disposed within said chamber;
an ionizable medium containing mercury sealed with said chamber; and
a means for controlling the mercury vapor pressure within said chamber during operation of said lamp comprising silver, bismuth and indium.

26. The fluorescent lamp of claim 25 wherein said means comprises an alloy of silver, bismuth and indium disposed within said chamber.

27. The fluorescent lamp of claim 25 wherein said means comprises an amalgam of silver, bismuth and indium disposed within said chamber.

28. The fluorescent lamp of claim 27 wherein said means comprises one or more amalgam pellets.

29. A lamp fill material for a fluorescent lamp characterized in that the fill material comprises an amalgam containing silver, bismuth, and indium.

30. The lamp fill material of claim 29 wherein the ratio of the number of atoms of mercury to the sum of the number of atoms of bismuth, indium and silver is between about 0.005:0.995 and about 0.15:0.85.

31. The lamp fill material of claim 29 wherein the ratio of the number of atoms of indium to the number of atoms of bismuth is between about 0.4:0.6 and about 0.20:0.80.

32. The lamp fill material of claim 29 wherein the number of atoms of silver to the sum of the number of atoms of bismuth and indium is between about 0.01:0.99 and about 0.15:0.85.

33. The lamp fill material of claim 29 wherein said amalgam forms one or more generally spherical pellets.

34. In a means for regulating the mercury vapor pressure in a fluorescent lamp comprising an amalgam containing indium, the improvement wherein said amalgam contains less than about 40 atomic percent indium.

35. The means for regulating the mercury vapor pressure in a fluorescent lamp of claim 34 wherein said amalgam contains less than about 35 atomic percent indium.

36. In a means for regulating the mercury vapor pressure in a fluorescent lamp comprising an amalgam containing indium, the improvement wherein said amalgam also contains silver.

37. The means for regulating the mercury vapor pressure in a fluorescent lamp of claim 36 wherein the amalgam contains less than about 25 weight percent indium.

38. A method of controlling the mercury vapor pressure in a fluorescent lamp comprising the step of dosing the lamp with a fill material containing silver, bismuth, and indium.

39. The method of claim 38 wherein the fill material comprises an amalgam.

40. The method of claim 38 wherein the fill material comprises an alloy.

41. The method of claim 38 wherein the fill material includes one or more pellets formed from an amalgam.

42. A method of dosing a precise amount of mercury into the light emitting chamber of a fluorescent lamp comprising the step of introducing one or more pellets into the chamber comprising an amalgam containing silver, bismuth and indium.

43. The method of claim 42 wherein the one or more pellets are formed by admixing silver, bismuth, indium and mercury, melting the admixture, and solidifying the molten admixture to form pellets having substantially uniform size, shape and composition.

44. The method of claim 43 wherein the one or more pellets are characterized in that the ratio of the number of atoms of mercury to the sum of the number of atoms of silver, bismuth and indium is between about 0.005:0.995 and about 0.15:0.85.

45. The method of claim 43 wherein the one or more pellets are characterized in that the ratio of the number of atoms of silver to the sum of the number of atoms of bismuth and indium is between about 0.01:0.99 and about 0.15:0.85.

46. The method of claim 43 wherein the one or more pellets are characterized in that the ratio of the number of atoms of indium to the number of atoms of bismuth is between about 0.4:0.6 and about 0.20:0.80.

47. A method of making a fluorescent lamp comprising the steps of:
(a) providing a glass envelope forming a light emitting chamber;
(b) positioning a pair of spaced electrodes within the chamber;
(c) filling the chamber with a fill gas;
(d) dosing the chamber with a fill material comprising mercury and the metals silver, bismuth, and mercury; and
(e) hermetically sealing the chamber.

48. The method of claim 47 wherein the fill material comprises an amalgam.

49. The method of claim 47 wherein the fill material comprises an alloy.

50. In a method of making a fluorescent lamp including the step of sealing an amalgam within the light emitting chamber of the lamp to thereby control the mercury vapor pressure within the chamber during operation of the lamp, the improvement wherein the amalgam contains silver, bismuth, and indium.
